(19) United States
(12) Patent Application Publication
(10) Pub. No.: US 2023/0013094 A1
(43) Pub. Date: Jan. 19, 2023

(54) PRECISION HIGH RESOLUTION SURFACE PROFILING APPARATUS AND METHOD

(71) Applicant: Cherry Systems Research Inc., Delta (CA)

(72) Inventor: Paul Toom, Delta (CA)

(21) Appl. No.: 17/372,297

(22) Filed: Jul. 9, 2021

(51) Int. Cl. G01C 7/04; G01B 11/30

(52) U.S. Cl. CPC G01C 7/04; G01B 11/306

(57) ABSTRACT

A surface profiler comprises at least one front support wheel and at least one rear support wheel for travelling along the surface of a profile to be measured, the rotational axes of said wheels being longitudinally spaced and collinear. A frame carried on the support wheels carries at least one inclinometer, and may also carry a first optical encoder to measure distance travelled. A subframe carried on at least two subframe wheels is pivotally coupled to the frame between the support wheels using a parallelogram linkage. The subframe support wheels are collinear with each other and with the support wheels. A second optical encoder measures the angle between the frame and the subframe. Incremental measurements of inclination angle provided by the inclinometer and the angle between the frame and the subframe, produce a series of elevations representing the surface profile.

### FIELD OF THE INVENTION

The invention relates generally to surveying instruments. More specifically the invention relates to a surface profiler for determining the contour and characteristics of a surface.

### BACKGROUND OF THE INVENTION

In surface profiling, a surface contour or profile is acquired by measuring the elevation of the surface at intervals along the surface. Surface profiling methods include either non-contact methods using optical (e.g. laser) or ultrasonic transducers, or contact-based methods using ground-engaging apparatus.

Contact-based profilers are generally characterized either as the walking or the rolling type. Walking profilers include those having spaced ground-engaging “feet” or pads that are alternately brought into engagement with the surface to be measured, as the profiler is moved over a distance. Examples of walking profilers are shown in U.S. Pat. No. 7,748,264 to Prem and U.S. Pat. No. 5,829,149 to Tyson. The majority of contact-based profilers are of the rolling type. Rolling profilers travel on wheels over the surface to be profiled. They may be manually propelled by a walking operator, or driven or towed by a vehicle, or by an on-board motor. Profilers that are propelled by a walking operator, even though they may use only wheels to contact the surface to be profiled, are also commonly called “walking” profilers. Such a profiler is disclosed in U.S. Pat. No. 6,775,914 to Toom.

Walking profilers may generally be further divided into two main types. One type typically includes a frame supported on wheels and an inclinometer, pendulum or other means to measure the inclination of the entire profiler's frame. A second type generally also comprises a frame supported on wheels, and further includes one or more separate marker or sensing wheels that do not support the profiler but are connected to a transducer for direct sensing of the position of the marker wheel in relation to the supporting wheels. A relatively common prior art approach for profilers of the latter type is to provide load bearing wheels at the front and rear ends of a frame and ground-engaging sensing means mounted between the load bearing wheels. Such an apparatus is exemplified by U.S. Pat. No. 5,535,143 to Face.

A surface profiler acquires a surface contour or profile by measuring the elevation of the surface at constant distance intervals along the surface, relative to a starting elevation. Sampling the surface in this manner produces a mathematical series of elevations, which collectively represent the physical surface along a specific line. The series can be used for a number of purposes relating to construction or ongoing management of the surface.

U.S. Pat. No. 4,741,207 to Spangler discloses a vertical distance measuring device mounted to a vehicle, which takes the form of a transducer that measures the distance to the road surface relative to the vehicle's frame. However, in order for the device to produce a profile, it is first necessary to determine a stable artificial plane of reference by double integrating the signal from a vertically oriented accelerometer and then to use the distance measuring device to measure from the artificial plane of reference to the pavement. This method and apparatus describe what has come to be known as an “inertial profiler”, because of the inertial nature of the vertically oriented accelerometer sensor, which is fundamental to deriving the artificial plane of reference. In the case of low speed profilers, it is not possible to create a stable artificial plane of reference since drift inherent to the technique will invalidate the reference over the fairly long period of manual data collection. This is because of limitations of the inertial accelerometers used to measure the acceleration normal to the road surface. Vertical acceleration is caused by profile “pushing” the profiler up or down in response to horizontal movement over the profile at fairly constant speeds. If the horizontal speed is low, the vertical acceleration will be correspondingly low. At the fairly low operating speed of a walking profiler (typically about 4 km/hour, depending on the roughness of the profile), the vertical acceleration would be much less than 1g (the acceleration of earth's gravity). Based on current accelerometer technology, this would result in a very low signal relative to noise, bias drift and other sources of error. The double integration of this weak signal would tend to yield an error value that would grow over the long profiling duration of, for example, 15 minutes required to collect data for a 1 km profile.

Various mathematical algorithms can be applied to the elevation series to calculate indices that are representative of the roughness or smoothness of the surface. The roughness relates to the discomfort that would be experienced by a passenger riding in a real or simulated vehicle that rolls over the surface. One of these indices is the International Roughness Index (IRI), which models the suspension of a nominal quarter of an automobile that is rolled over the surface. The IRI algorithm computes the total travel of the quarter car's suspension per unit of distance traveled while rolling over the subject profile—the greater the travel, the higher the IRI value or roughness.

IRI is increasingly being used for surface construction contract management. The quality of a newly constructed surface is compared to its contractual end product specification to determine if the finished surface is compliant with the specification. Construction contracts can be managed using surface profilers, with contract bonuses and penalties payable depending on profile test results. IRI is the preferred index to determine profile quality. It should be apparent that instruments used to acquire the elevation series representing the actual surface profile that are used to calculate the IRI must therefore have high levels of accuracy and repeatability.

IRI is also being used for management of large-scale networks of roads within the jurisdictions of state departments of transport and highways, where non-contact surface profilers capable of collecting data at highway speeds are commonly being used. These are typically inertial profilers that measure elevation with reference to an inertial reference derived by double integrating the signal from a vertically oriented accelerometer. Due to their inherent limitations, such inertial profilers must be calibrated or verified against a benchmark reference or a more accurate profiling instrument to validate the data they acquire. Such benchmark devices have been defined by the United States Federal Highway Administration as “Reference Profilers”.

In recent years, research and development into roads and applications of measured road profiles has resulted in the desire for more spectral detail within the profiles. This desire arises from the interest in studying the friction and other interactions between vehicle tires and surface textural features such as may be found in longitudinal and transverse tining, longitudinally ground pavements and those pavements that use very coarse granular materials such as chip seal and stone matrix asphalt.

Low speed contact-based manual reference profilers do not use vertically-oriented accelerometers to sense vertical acceleration of the vehicle frame to derive an artificial reference plane. Instead, they use inclinometers to measure the longitudinal tilting of the vehicle frame as a basis for determining the elevation of the frame. The inclinometers are typically accelerometers that measure the vector component of the earth's acceleration in the horizontal direction (orthogonal to gravity) that results when they are not perfectly horizontal with respect to the plane of the earth. This method is therefore not speed dependent.

Reference profilers must be capable of measuring fine profile features having very short wavelengths. However, prior art profiling devices employing ground-engaging wheels and inclinometers are mathematically limited to measuring only wavelengths greater than the longitudinal distance between the rotational axes of their wheels. Specifically, inclinometer-based profilers having a frame supported by a forward wheel and a rearward wheel spaced apart by wheelbase separation distance W have the following transfer function which provides the inclinometer signal gain H at different wavelengths A, where the straight brackets signify the absolute value of the enclosed function:

$$H ( λ ) = \vert \frac{sin ( \frac{π W}{λ} )}{\frac{π W}{λ}} \vert$$

It can easily be seen that the gain falls to precisely zero where λ=W, since sin(π)=0, and is very low for λ between 0 and Wwavelength. This inclinometer-based profiler configuration is in fact an exact mechanical analog of a moving average filter having sample length of W, and the challenge presented is that the geometry of the profiler apparatus actually filters out the wavelengths that are of interest, namely those shorter than W.

It is common to design and build profilers by mounting inclinometers onto frames supported by wheels. However, inclinometers perform best in applications that are inertially non-accelerated, and where the frequency of real inclination signal is well below their maximum operating frequency which is typically 30 Hertz (−3 dB). The frame wheel spacing W determines the shortest wavelength the profiler can measure although there is clear direction from the United States Federal Highway Administration pooled fund working group to measure shorter wavelengths, for example, 76 mm or about 3 inches. Shorter wavelengths mandate shorter frame wheel spacing which results, for a particular profiling speed, in the need for the inclinometer to measure higher frequency and amplitude signal which causes errors and degrades surface profiler performance. Mounting an inclinometer onto a short frame supported by wheels is therefore contraindicated, particularly where the profiler will be used to measure profiles of road pavements having high texture.

U.S. Pat. No 9,404,738 to Toom discloses a surface profiler that uses dual distance measuring lasers and collinear wheels to produce a high resolution, continuous surface profile. However, the apparatus is necessarily large due to the dimensions and arrangement of the lasers, and is expensive, particularly given the need for two lasers. The approach results in an excellent surface profiler that accurately acquires profile independently of speed and that is operable down to zero speed, but does not lend itself to compactness and affordability. This patent teaches the value of measuring profile slope over short longitudinal distances as an alternative means of acquiring a surface profile. However, it will be shown that the slope may be measured using a mechanical apparatus rather than two lasers and achieve comparable performance.

It is therefore an object of this invention to provide a surface profile measuring apparatus that will address one or more of the issues present with currently available profilers.

It is further an objective of this invention to provide an apparatus and method to precisely measure a surface profile with high resolution, meaning that very short wavelength profile features may be accurately identified and measured.

The present invention, given its high accuracy and repeatability, while finding uses in several industries and for many purposes, will be of particular value in both the contract management of new surface construction and as a reference standard for certification of other instruments.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

The invention provides an accurate surface profiling apparatus and method intended to be useful as a reference profiler, useful in calibrating other profiling devices, and capable of determining profile features smaller than the wheel base of the profiler. The profiler has the additional benefit of operability that is independent of speed down to zero speed, and while speed is varying.

The surface profiling apparatus according to the invention comprises a frame supported on a pair of wheels, one at each end of the frame, one or more devices for measuring inclination of the frame, the one or more devices preferably each comprising an inclinometer, a subframe supported on a pair of closely-spaced wheels and an optical encoder to measure the angle between the frame and the subframe. The apparatus may also comprise a device for measuring longitudinal distance travelled by the profiler. One or more wheels may be attached to one or more axles or arms extending orthogonally from the frame to provide stability and lateral support.

The wheels supporting the subframe are placed relatively close together, to capture short distances, which are defined as being distances shorter than the distance between the two supporting wheels. The profiler measures surface profile in a continuous method based on differential calculations using small distance increments to compute a continuous mathematical series of elevations at the single mid-point of the subframe support wheels. The inclinometer defines a first angle and the subframe angle optical encoder define a second angle; the sum of the angles is applied to the differential calculus calculation of the continuous mathematical series to compute the elevation at a given point on the profile.

It is an object of this invention to provide a more stable operating environment for the inclinometer by mounting it onto a frame with the longest practical frame wheel spacing, while measuring short wavelength profile using a subframe with short wheel spacing and employing an optical encoder rather than an inclinometer to measure the short wavelength angular information. The optical encoder short wavelength angular information is mathematically combined with the inclinometer long wavelength angular information to provide a spectrally complete and accurate profile. In one aspect the wheel spacing of the frame supporting the wheels can be increased by extending both ends of the frame. This provides a more stable environment for the inclinometer by reducing the frequency and amplitude of vertical motion of the frame attributable to interaction of the frame wheels with road texture and profile. This also enables storage of the entire surface profiler in a smaller enclosure and easier transport. The optical encoder, unlike the inclinometer, performs very well in inertially accelerated environments and at very high frequencies of real angle signal input. Therefore, the inclinometer, mounted to a frame with large wheel spacing, operating in a semi-stable non-accelerated environment, provides the long wavelength profile component, onto which the subframe optical encoder adds the short wavelength profile component.

Since the inclinometer, despite its mounting on a long frame, is influenced by longitudinal acceleration it is preferable to propel the profiler at a very constant speed, that is, with nominally zero acceleration. Propulsion of a walking profiler subjects the inclinometer to the acceleration inherent in the walking motion of the operator. To avoid acceleration-induced noise of the inclinometer it is preferable to employ motorized propulsion to provide very constant speed drive and, where necessary, smooth and constant accelerations and decelerations. This may be accomplished using several types of motors capable of constant speed operation including brushless DC motor, stepper motor and servomotor, with or without a gearbox that would convert the motor into a gearmotor. Motors that have constant drive speed, or that employ closed loop speed control using feedback from a shaft coupled hall effect sensor or optical encoder, including an optical encoder coupled to a frame wheel, could be used to provide very constant speed propulsion which should eliminate most of the unwanted longitudinal acceleration noise necessary for the highest quality inclination signal and resulting profile.

In another aspect according to the invention, a surface profiling apparatus comprises a frame, a plurality of support wheels supporting the frame, at least two of the support wheels being separated by a support wheel spacing W and being aligned to contact a surface being profiled in a longitudinally collinear manner, a longitudinal distance measuring apparatus supported by the frame for measuring distance traveled by the surface profiling apparatus, a longitudinal inclination measuring apparatus supported by the frame for measuring an inclination angle α of the frame relative to the horizontal plane of the earth, a subframe pivotally coupled to the frame, a plurality of subframe support wheels supporting the subframe, at least two of the subframe support wheels being separated by a subframe wheel spacing L and being aligned to contact the surface being profiled in a longitudinally collinear manner with the at least two support wheels, and a subframe angle measuring apparatus supported by the subframe for measuring an angle 13 between the frame and the subframe. The longitudinal inclination measuring apparatus may be an inclinometer. The subframe support wheels may be equidistant from the mid-point of the frame. The subframe angle measuring apparatus may be an optical encoder.

In a further aspect, the subframe further comprises a subframe member, a subframe support member pivotally coupled to the subframe member; and a rotational linkage pivotally coupled to the frame and to the subframe support member. The subframe support wheels may be attached to the subframe member at the subframe wheel spacing L wherein the subframe spacing L is shorter than the support wheel spacing W. The rotational linkage may be a parallelogram rotational linkage. The angle measuring apparatus may be an optical encoder attached to the subframe member. The angle measuring apparatus may be a magnetic encoder attached to the subframe member. The subframe support member may be pivotally coupled to the subframe member at the subframe member's midpoint. The subframe support wheels may be equidistant from the mid-point of the frame.

In another further aspect, the longitudinal distance measuring apparatus is rotationally linked to an axle of one of the support wheels. The longitudinal distance measuring apparatus may be an optical encoder.

In another further aspect, the surface profiling apparatus comprises a motorized drive adapted to move the profiling apparatus along the surface to be profiled. In another further aspect, the surface profiling apparatus comprises attachment means by which the surface profiling apparatus may be attached to a motorized vehicle to move the surface profiling apparatus along the surface being profiled.

In another further aspect, the surface profiling apparatus comprises an operator interface to control the profiling apparatus. The operator interface may be associated with a cabinet associated with the frame. The cabinet may house operational equipment, the operational equipment being selected from the group consisting of: one or more internal sensors, a power supply, power level monitor, signal conditioning equipment, real time clock, distance pulse counters, digital input/output and multi-channel 16 bit analog to digital converter, computer and non-volatile memory.

In another further aspect, the surface profiling apparatus comprises a transverse inclination measuring apparatus, supported by the frame and oriented substantially perpendicular to the longitudinal inclination measuring apparatus. The transverse inclination measuring apparatus may be an inclinometer.

In another aspect according to the invention, a method of profiling a surface using a surface profiler mounted on a plurality of support wheels, at least two of the support wheels being aligned to contact the surface in a longitudinally collinear manner, and a subframe supported by a plurality of subframe support wheels, at least two of the subframe support wheels being aligned to contact the surface in a longitudinally collinear manner and being mounted collinearly with the frame wheels and separated by a distance L, comprises acquiring data relating to a longitudinal distance ΔD travelled by the surface profiler from a longitudinal distance measuring apparatus mounted on the surface profiler, an angle α from a longitudinal inclination measuring apparatus comprising a first inclinometer mounted on the surface profiler, and an angle β between the frame and the subframe from an optical encoder, calculating an incremental change in surface elevation ΔE, using the formula ΔE=ΔD sin(α+β), and adding the incremental change to an accumulated elevation series which represents a profile of the surface.

In a further aspect, the method is applied at periodic intervals. The periodic intervals may be time increments, Δt, and Δt may be 1 millisecond. The periodic intervals may be longitudinal distance increments, ΔD, and ΔD may be 1 millimeter.

In another further aspect, the step of acquiring data further comprises acquiring data relating to a transverse angle x from a transverse inclination measuring apparatus comprising a second inclinometer supported by the profiler to correct the angle α for cross-axis error.

In a still further aspect, the method including acquiring data relating to the transverse angle χ is applied at periodic intervals. The periodic intervals may be time increments, Δt, and Δt may be 1 millisecond. The periodic intervals may be longitudinal distance increments, ΔD, and ΔD may be 1 millimeter.

In another aspect according to the invention, a method of profiling a surface using a surface profiler mounted on a plurality of support wheels, at least two of the support wheels being aligned to contact the surface in a longitudinally collinear manner, the surface profiler further comprising a subframe connected to the surface profiler and supported by a plurality of subframe support wheels, at least two of the subframe support wheels being aligned to contact the surface in a longitudinally collinear manner, comprises moving the surface profiler a longitudinal distance increment ΔD, obtaining an angle α from a longitudinal inclination measuring apparatus comprising a first inclinometer mounted on the surface profiler, obtaining an angle β from an angle measuring apparatus comprising an optical encoder connected between the subframe and a frame of the surface profiler, calculating an incremental change in surface elevation ΔE, using the formula ΔE=ΔD sin(α+β), and adding the incremental change to an accumulated elevation series which represents a profile of the surface.

In a further aspect, the method is applied at periodic intervals. The periodic intervals may be time increments, Δt, and Δt may be 1 millisecond. The periodic intervals may be longitudinal distance increments, ΔD, and ΔD may be 1 millimeter.

In another further aspect, the method comprises a further step of correcting the angle α for cross-axis error using a transverse angle χ, the transverse angle χ being obtained from a transverse inclination measuring apparatus comprising a second inclinometer supported by the surface profiler.

The foregoing is intended as a summary only and of only some of the aspects of the invention. It is not intended to define the limits or requirements of the invention. Other aspects of the invention will be appreciated by reference to the detailed description of the preferred embodiments. Moreover, this summary should be read as though the claims were incorporated herein for completeness.

### BRIEF DESCRIPTION OF THE DRAWINGS

The preferred embodiment of the invention will be described by reference to the drawings thereof in which:

FIG. 1 is a side elevation view of a surface profiler according to an embodiment of the invention;

FIG. 2 is a front elevation view of the surface profiler of FIG. 1;

FIG. 3 is a side elevation view of a propulsion means of the surface profiler of FIG. 1;

FIG. 4 is a side elevation view of the propulsion means of FIG. 3 demonstrating the articulation of the front and rear arms about the center pivot axle

FIG. 5 is a front elevation view of the surface profiler of FIG. 1 coupled to the propulsion means of FIG. 3 according to an embodiment of the invention;

FIG. 6 is a side elevation view of the surface profiler of FIG. 1 showing the extension of the telescoping arms of the frame to provide improved performance of the inclinometer;

FIG. 7 is a block diagram of the control components of the surface profiler;

FIG. 8 is a schematic diagram illustrating the geometry applied to create a surface profile;

FIG. 9 is a graph of the performance response of the surface profiler of FIG. 1 showing elevation gain in relation to wavelength for the cases of subframe support wheels plus inclinometer and inclinometer only.

### DETAILED DESCRIPTION OF THE PREFERRED EMBODIMENT

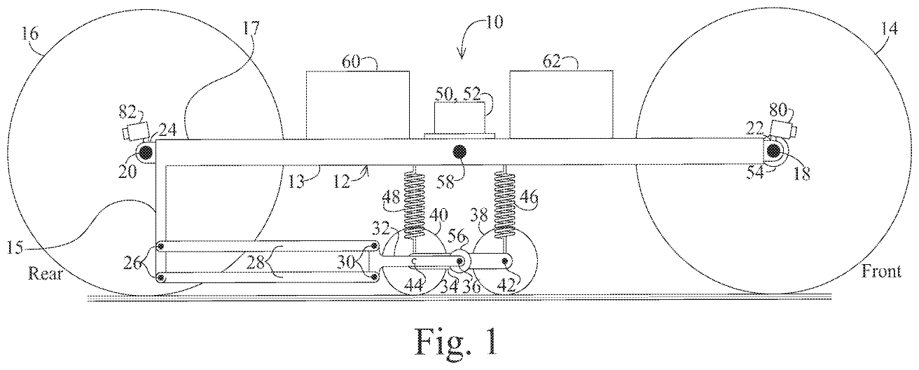

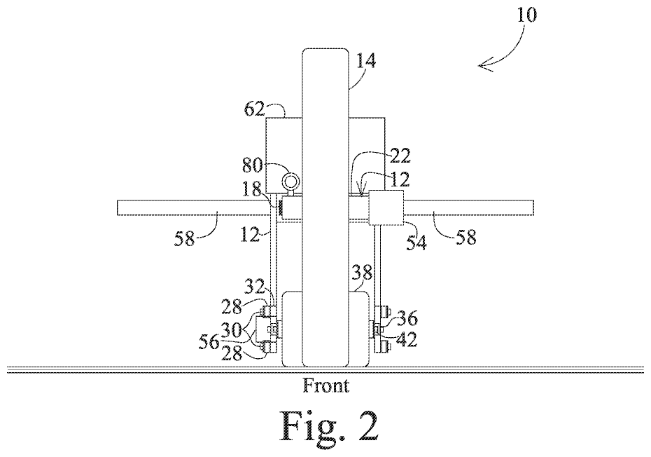

Referring now to FIGS. 1, 2 and 6, a surface profiler 10 according to the invention comprises a frame 12 which is supported by a front support wheel 14 and a rear support wheel 16.

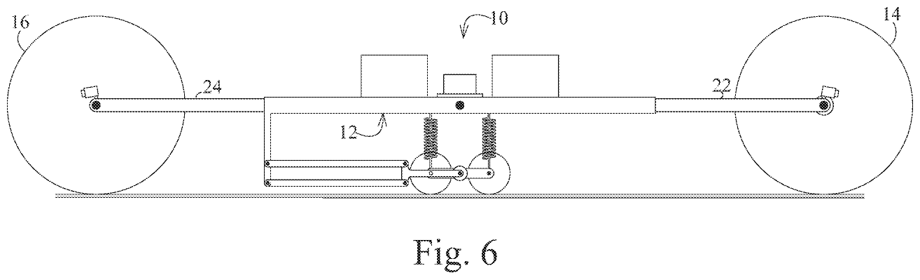

Front and rear support wheels 14, 16 are spaced apart longitudinally on the frame 12, separated by a distance W, and are collinear, for travel along the same line. Front and rear support wheels 14, 16 are mounted for rotation on respective front and rear axles 18, 20 that are supported on frame 12. Frame 12 comprises a longitudinal member 13 to which front and rear support wheels 14, 16 are attached and a descending vertical member 15 depending from a first end 17 of the longitudinal member 13 to connect the subframe apparatus discussed following. The first end 17 is depicted as being the rear of the frame 12 but descending vertical member 15 could also depend from the frame 12 towards the front of the longitudinal member 13. Frame 12 is preferably made of a suitably strong and lightweight material, such as aluminum, and is preferably of tubular or of extruded rigid structural form. Similarly, aluminum or a stable high-grade plastic such as acetal may be chosen to minimize the mass of the wheel hubs. The frame 12 may be made longer, and the support wheel spacing increased, by extending telescoping arms 22, 24 as shown in FIG. 6. Front and rear support wheels 14, 16 are preferably composed of a suitable wheel material, such as solid natural or neoprene rubber, for durability, to keep wheel mass low and to provide compliance between the frame 12 and the surface to be profiled, i.e. to average out micro-texture, and to reduce coupling of vibration from the front and rear support wheels 14, 16 to the frame 12 and instruments of the surface profiler 10, discussed in further detail below. If additional stability is desired, a third wheel may be attached to an arm (not shown) that extends orthogonally from a side of the frame 12 in order to support the surface profiler 10 and prevent it from tipping to the side. Alternatively, the frame 12 of the surface profiler 10 may be widened and one or more wheels may be attached to one or more axles or arms extending orthogonally from the frame 12 to provide stability, lateral support and coupling to a motor drive.

Front support wheel 14 drives axle 18 and rear support wheel 16 drives axle 20. A longitudinal distance measuring apparatus 54 is preferably coupled to the rotational motion of either of the front support wheel 14 or the rear support wheel 16 for generating digital pulses related to the distance traveled. The longitudinal distance measuring apparatus 54 is preferably an optical encoder.

A longitudinal inclination measuring apparatus 50 is mounted on the frame 12 with its measuring axis in the longitudinal direction of the surface profiler 10, i.e. along the path of travel. The longitudinal inclination measuring apparatus 50 measures the orientation of the frame 12 with respect to the notional horizontal plane of the earth and preferably comprises an inclinometer. Where required for certain applications, such as to correct for tilting of the surface profiler 10 as discussed in further detail below, a transverse inclination measuring apparatus 52 may be provided near the center of the frame 12 with its measuring axis in the transverse or orthogonal direction, i.e. perpendicular to the path of travel. The transverse inclination measuring apparatus 52 is also preferably an inclinometer.

At least two subframe support wheels 38, 40 are rotationally coupled by respective subframe shafts 42, 44 to a subframe 34 that is rotationally supported by a first pivoting connection 36, which may be at any point between, and including, the ends of subframe 34, but is preferably at the mid-point between the subframe support wheels 38, 40. The first pivoting connection 36 is conveniently comprised of shoulder bolts and sleeve bearings. A belt or track (not shown) may be wrapped around, and turned by, the subframe support wheels 38, 40 in order to obtain an average of the slope between the subframe support wheels 38, 40. The belt or track would be made conveniently of natural rubber or neoprene rubber. Longitudinal distance measuring apparatus 54 may alternatively be coupled to the rotational motion of either of the subframe support wheel 38 or the rear subframe support wheel 40. The subframe 34 is rotationally supported by a subframe support 32 which is in turn supported by two arms of a parallelogram rotational linkage 28 coupled to the frame 12 and more preferably coupled to the vertical member 15 of the frame 12. The parallelogram rotational linkage 28 is rotationally supported on the frame 12 by a first double pivoting connection 26, and on the subframe support 32 by a second double pivoting connection 30. Each of the first and second double pivoting connections 26, 30 are also conveniently comprised of shoulder bolts and sleeve bearings. The subframe suport wheels 38, 40 are collinear with the front and rear support wheels 14, 16 and separated on the subframe 34 by a subframe wheel spacing L, where L is shorter than the support wheel spacing W between the front and rear support wheels 14, 16. The first pivoting connection 36 of the subframe 34 is rotationally linked to a subframe angle measuring apparatus 56 that is connected to subframe support 32, in order to measure the angle of the subframe 34 relative to the subframe support 32. The parallelogram rotational linkage 28 between the frame 12 and the subframe support 32 maintains the longitudinal axis of the frame 12 parallel to the longitudinal axis of the subframe support 32, therefore angular measurements referenced to the subframe support are also referenced to the frame 12. The subframe support wheels 38, 40 are preferably equidistant from the mid-point of the frame 12. The subframe support wheels 38, 40 may be longitudinally spaced apart on the subframe 34 and may be attached to the subframe 34 at a specified separation distance L, being shorter than the separation distance W between the support wheels 14, 16. The parallelogram rotational linkage 28 between the frame 12 and the subframe support 32, with first and second double pivoting connections 26, 30 to the frame 12 and subframe support 32, respectively, could be replaced with a simple rotational linkage with a single pivot point at each end but this would require another optical encoder to measure the angle between the frame 12 and the parallelogram linkage 28 which would add cost and possibly decrease accuracy. Two springs with dampers 46, 48 apply downward force from the frame 12 to the subframe 34 to ensure stable tracking of the subframe support wheels 38, 40 over the surface. Alternatively, a spring with damper (not shown) may apply downward force from the frame 12 to the subframe support 32, which would in turn apply downward force on the subframe 34. All of the support wheels 14, 16 and the subframe support wheels 38, 40 may be of the same diameter and width. A wider wheel, with soft or low durometer tire, is preferred to emulate the behavior of an automobile tire, particularly in regard to modeling the penetration of the texture of the road pavement into the tire and determining the average penetration into the tire and therefore the resulting elevation of the tire and wheel above the pavement surface.

The longitudinal distance measuring apparatus 54 is rotationally linked to an axle 18, 20 of one of the support wheels 14, 16, and may be an optical encoder. The longitudinal inclination measuring apparatus 50 may be an inclinometer. The apparatus may further comprise a transverse inclination measuring apparatus 52, oriented substantially perpendicular to the longitudinal inclination measuring apparatus. The transverse inclination measuring apparatus may also be an inclinometer. The subframe angle measuring apparatus 56 is preferably an optical encoder or a magnetic encoder and is more preferably an absolute-type optical encoder. The absolute type optical encoder is preferred since it retains information of its angular position when its power is turned off. The incremental type optical encoder does not retain information of its angular position when its power is turned off. The incremental type optical encoder must be calibrated to set it to zero angle after power is turned on. Zero angle of subframe angle optical encoder 56 will occur when all of the support wheels 14, 16 and subframe support wheels 38, 40 are aligned on a perfectly straight line or planar surface.

In a further aspect, the surface profiler 10 may be manually pushed or pulled by attaching a handle or other manual propulsion means to move it along the surface to be profiled. The surface profiler 10 may also be towed or pushed by external motorized means. The surface profiler 10 may also be internally integrated into a motor vehicle of any description with or without human driver or operator. Finally, the surface profiler 10 may be integrated into an autonomous vehicle and be equipped with self-driving means including motorized propulsion, computer vision and steering. Using a motor to drive support wheel 14 or 16 causes a torque of the frame 12 which may cause unbalanced loading on the wheels and an error of longitudinal inclination measuring apparatus 50, which is undesirable. Using a motor to drive the wheel coupled to longitudinal distance measuring apparatus 54 may cause slippage of the wheel and an error of the longitudinal distance measuring apparatus 54, which is also undesirable. Using a motor to drive any of support wheels 14, 16, and subframe support wheels 38, 40 is therefore contraindicated and alternative propulsion means are required. Preferably the frame 12 further comprises a support axle 58, which provides means to push or pull the profiler at its center while avoiding unbalanced loading on support wheels 14, 16.

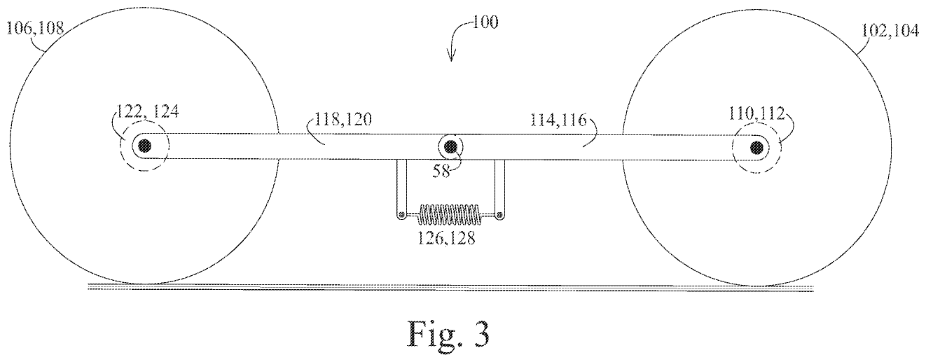

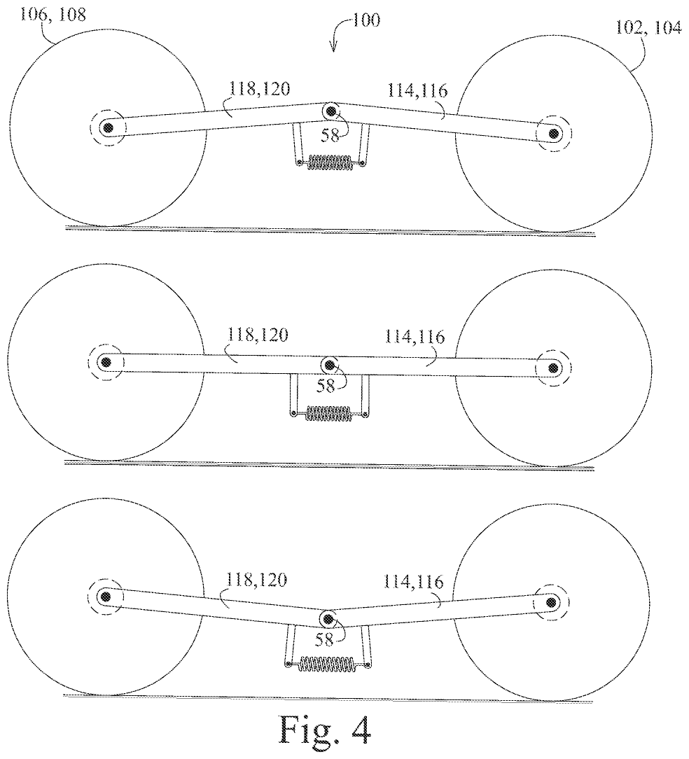

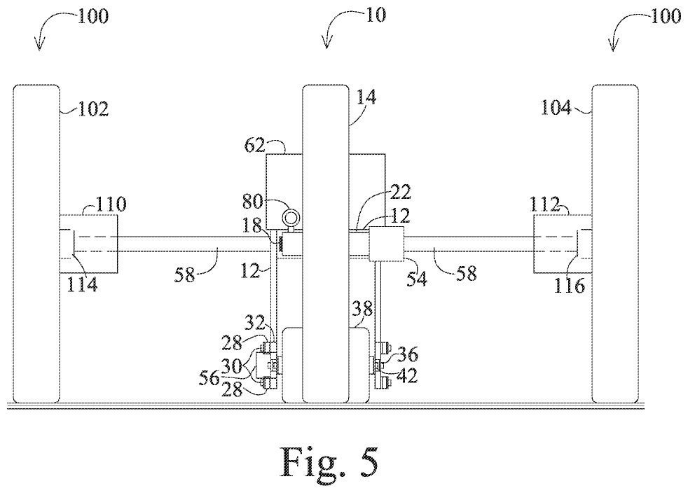

Referring now to FIGS. 3, 4 and 5, a motorized propulsion mechanism 100 for the surface profiler 10 comprises an outrigger-type support on both right and left sides of frame 12, each side consisting of two arms supported by wheels which are individually driven by motors. On the right-side arms 114, 118 are supported by wheels 102, 106 and on the left-side arms 116, 120 are supported by wheels 104, 108. The central end of each arm is pivotally attached to axle 58 allowing for independent motion or articulation of each arm as shown in FIG. 4. The pivots consist conveniently of sleeve bearings secured by circular clips. Motors 110, 112, 122, 124 individually drive axles and wheels 102, 104, 106, 108 respectively. Springs 126, 128 provide upward force on axle 58 to compensate for the downward force on axle 58 presented by the weight of the rotationally coupled surface profiler 10. The spring ratings are selected so that the springs 126, 128 together support about 50% of the load of surface profiler 10 and support and maintain surface profiler 10 in a vertical orientation. Cameras 80, 82 mounted to the two ends of surface profiler 10 and computer vision software of computer and memory 64 provide guidance and steering of surface profiler 10, 100 by individually controlling the speeds of motors 110, 112, 122, 124 with the primary objective of maintaining very constant speed while collecting profile data. The longitudinal distance measuring apparatus 54 may be used as the source of speed signal for maintaining constant speed as part of a feedback-controlled motor speed controller. Steering is accomplished by setting the speed of the left side motors 112, 124 differently from the speeds of the right side motors 110, 122 and vice-versa. The compliance of the preferably rubber support wheels 14, 16, and subframe support wheels 38, 40 enables small steering changes sufficient to navigate normal road curvatures. The motors 110, 112, 122, 124 can propel surface profiler 10, 100 both forward and reverse, enable profiling in both directions and performance of two way, or closed-loop, profiles without the need to turn around the surface profiler and propulsion mechanism 10, 100. Steering may follow painted lines, chalk lines, string lines, GPS or any other steering directions. Lines may be white, black, red or any other color and color may be used as the basis for path detection. Alternatively, string thickness or elevation above the pavement surface may be used as a basis for path detection. The computer vision may be guided using the Hough Line Transform or other suitable algorithm or means or for detecting and following a line or curve to establish the path of the surface profiler and propulsion mechanism 10, 100.

Referring now to FIG. 6, the length of the frame may be made longer, and the frame wheel spacing increased, by extending telescoping arms 22, 24. The telescoping arms may be locked into position using a thumbscrew or similar device (not shown). The increased wheel spacing results in a more stable operating environment for inclination measuring apparatus 50, 52, with reduced vibration and frequency and amplitude of signal.

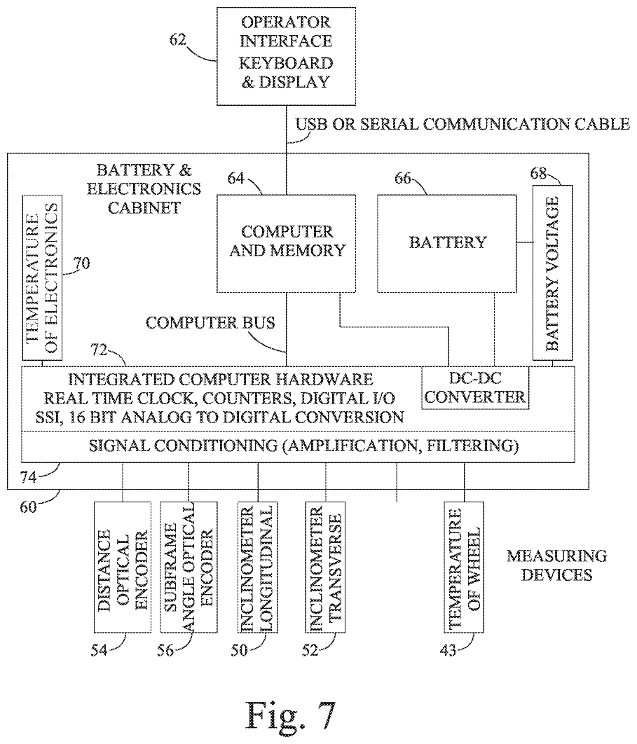

Referring now to FIG. 7, an operator or human-machine interface 62 is attached to the frame 12. Operator interface 62 may comprise any suitable interface means, such as a keyboard, touchscreen and/or display screen, to allow the operator to control the profiler, including seeing and controlling data input, output, system information, communication, and provision of information.

An enclosure 60 attached to the frame 12 contains the operational equipment necessary to operate the surface profiler 10. For example, the enclosure 60 contains the computer and memory 64 required to acquire and apply the signals and readings obtained from the measuring devices and other apparatus carried on the surface profiler 10, including the longitudinal distance measuring apparatus 54, subframe angle measuring apparatus 56, and one or both inclination measuring apparatus 50, 52. It may also obtain information from any other sensors that may be provided, such as a wheel temperature sensor 43. Enclosure 60 may also contain battery 66 or any other suitable power supply, internal sensors such as an electronics temperature sensor 70 and battery voltage monitor 68, and signal conditioning equipment including amplification and signal conditioner 74 (e.g., such as provided by a filter) and an integrated computer hardware interface 72 containing suitable apparatus such as a real time clock, distance pulse decoders and counters, Synchronous Serial Interface (SSI) or parallel data bus for communication with absolute optical encoders, digital input/output and multi-channel 16 bit analog to digital converter.

Data acquisition is controlled through the operator interface 62. Under control of the computer and memory 64 the distance is measured using longitudinal distance measuring apparatus 54 which sends electrical pulses representative of the distance traveled to decoders and counters on the intgrated computer hardware interface 72 in order to trigger acquisition (i.e. digital conversion and storage) of analog voltages and subframe angle optical encoder 56 at appropriate distances. The angle between the subframe support 32, and therefore the frame 12, and the subframe 34 is measured using subframe angle measuring apparatus 56 which sends electrical pulses representative of the angle between frame and subframe to counters of the integrated computer hardware counters or Synchronous Serial Interface (SSI) in the integrated computer hardware interface 72. The analog voltages from the inclination measuring apparatus 50, 52, temperature sensor 43, and battery 66 are acquired by the signal conditioner 74 and the multi-channel 16 bit analog to digital converter on the hardware interface board 72.

Computer and memory 64 periodically obtain signals from all measuring devices attached to the profiler, preferably substantially simultaneously measuring: the total longitudinal distance travelled, the inclination of the frame 12 and the angle between the frame 12 and the subframe 34. This may be most simply done at constant distance intervals ΔD, such as 1 mm. It is important to capture data from all devices at the same instant in order for the algorithm of the method to provide the most accurate profile results. Conveniently the total longitudinal distance travelled is acquired by counting pulses from the longitudinal distance measuring apparatus 54 and the angle between the frame 12 and subframe 34 is acquired using the Synchronous Serial Interface (SSI) from the subframe angle measuring apparatus 56 while the inclination is obtained from the longitudinal inclination measuring apparatus 50 by converting the analog voltage from to digital form using an analog to digital converter with multiple analog inputs. Alternatively, instead of constant distance intervals, measurements may be taken at constant time intervals or any other suitable interval. For example, the computer and memory 64 may use a real time clock to determine when to obtain the measurement signals, namely at intervals of constant time such as 1 msec. Distance change AD may be determined by inspection of the distance travelled at each 1 msec interval, although it may not have a constant value from interval to interval, if the speed of the profiler is not constant.

Calculations

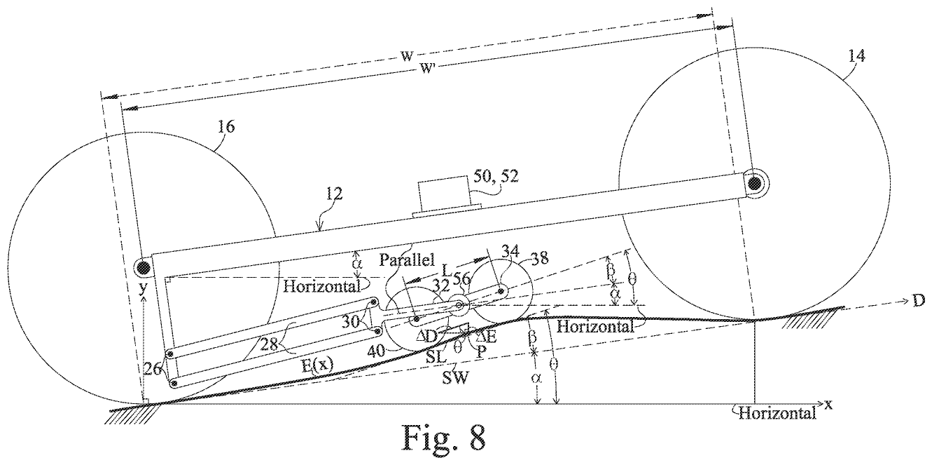

Referring now to FIG. 8, the invention uses the following method to produce a mathematical series that accurately represents the surface profile.

First, the following constants are acquired:

W is the distance between the rotational axes of the support wheels 14, 16 in meters. W is also therefore the distance between the points of contact of the support wheels 14, 16 on the surface being profiled. While W is not used directly in the calculation of the profile elevation series it does define the wavelength at which the longitudinal inclination measuring apparatus 50 frequency response rolls off to zero and the subframe support wheels 38, 40 and subframe angle measuring apparatus 56 take over. The support wheels 14, 16 and subframe support wheels 38, 40 must be collinear for smooth and accurate transition between the angle from the inclination measuring apparatus 50 and the angle from the subframe angle measuring apparatus 56.

L is the distance between the subframe support wheels 38, 40, in meters. The subframe support wheels 38, 40 are preferably substantially equidistant from the mid-point of the frame 12 and the mid-point of the subframe 34.

α is the angle between the frame 12 and the horizontal plane of the earth in radians, as measured by the longitudinal inclination measuring apparatus 50.

β is the angle between the frame 12 and the subframe 34 as measured by the subframe angle measuring apparatus 56. The subframe angle measuring apparatus 56 measures the angle between the subframe 34 and subframe support 32. Since the parallelogram rotational linkage 28 maintains the longitudinal axis of the subframe support 32 precisely parallel to the longitudinal axis of the frame 12, the subframe angle measuring apparatus 56 therefore measures the angle between the frame 12 and subframe 34. This allows direct referencing, and therefore summation, of angles a and β.

θ is the angle between SL, the line connecting the points where the subframe support wheels contact the profile surface, and the X axis, which is the horizontal plane of the earth, meaning that θ=α+β.

There is a continuous elevation profile function f(x) called E(x):

y=E(x)

For a point P on the profile function E(x) mid-way between the rotational axes of the support wheels 14, 16 and mid-way between the points where the subframe support wheels 38, 40 contact the profile, using principles of differential calculus, the slope at point P is:

$$slope = \frac{dy}{dx}$$

For a right-angle triangle having point P at its lower corner, the hypotenuse has the slope of a tangential line intersecting P that forms the angle θ with the horizontal plane of the earth. The slope at point P is given by the angle θ. The mean value theorem states that a point P on the profile between the points of contact of the subframe support wheels 38, 40 on the profile must have the same slope as that defined by the points of contact of the subframe support wheels 38, 40 on the profile. We estimate that this value occurs at the mid-point between the subframe support wheels 38, 40:

$$slope = tan ( θ )$$

$$tan θ = \frac{dy}{dx}$$

We see that for a very small incremental change in horizontal distance Δx there will be a corresponding very small change in elevation ΔE according to the profile slope at point P as determined by the angle θ. For very small incremental changes in horizontal distance Δx, for example less than 1 mm, and elevation ΔE:

$$tan θ = \frac{Δ E}{Δ x}$$

In practice, we cannot easily measure Δx. We can, however, readily measure distance along the surface of the pavement ΔD. Data collected at constant intervals of ΔD will result in values of Δx that are not constant, but sufficiently constant for practical purposes, given the very small angles θ that are normally encountered in profiling work, that is, ΔD is approximately equal to Δx, and it is acceptable to ignore the difference. Alternatively, the Δx values may be corrected given the ΔD and θ values:

Δx=ΔD cos θ

Therefore, using trigonometric identities:

$$sin θ = \frac{Δ E}{Δ D}$$

$$Δ E = Δ D sin θ$$

$$Δ E = Δ D sin ( α + β )$$

And to build a mathematical series accurately representing the profile from m samples of data, starting at elevation E₀, sampled every ΔDₙ distance interval, the resulting end elevation Eₘ may be defined as follows:

$${E}_{m} = {E}_{0} + {\sum }_{n = 1}^{m} ( Δ {D}_{n} sin ( {∝}_{n} + {β}_{n} ) )$$

E₀ may be taken from existing records for the elevation above sea level of the test site. Alternatively, a relative measure may be sufficient for the purposes of the profile data such that E₀ is set to zero.

In order to build the profile at every n distance interval it is necessary to acquire the values ΔDₙ, αₙ, and βₙ from the measuring devices. Therefore, at any given point along the profile, the necessary readings are acquired from the longitudinal distance measuring apparatus 54, the longitudinal inclination measuring apparatus 50 and the subframe angle measuring apparatus 56.

Note that the subframe support wheels 38, 40 and subframe angle measuring apparatus 56 may be removed from the surface profiler 10, which would continue to function as an accurate profiler using only αₙ, therefore βₙ, equal to zero. The profiler frequency response would roll off toward and become zero at W.

### Calculating the Profile

The data collection process is initiated by the operator, and continues until the operator stops the process. Once stopped, the data collected can be saved to a USB-connected flash drive or other storage device. Also, the operator may perform diagnostics and calculations such as computation of roughness indices such as the IRI.

The following process is used to measure the profile. First, a benchmark survey data may be used to establish the local elevation as E₀ or the starting elevation may simply be set to 0. Data acquisition may be at intervals of constant time Δt or of constant distance ΔD. In the case of Δt, data acquisition may be triggered by a real time clock in the integrated computer hardware 72. In the case of ΔD data acquisition may be triggered by counting pulses of longitudinal distance measuring apparatus 54 using a counter of integrated computer hardware 72, which count of pulses is digitally compared with the predetermined counts necessary to travel ΔD. Either a Δt or a ΔD event may start data acquisition by the integrated computer hardware 72 or cause a computer interrupt which may cause the computer and memory 64 to control the data acquisition. Therefore, at Δt, such as every millisecond, or every incremental distance ΔD, such as every millimeter, the following steps are performed by integrated computer hardware 72 or a computer subroutine or function:

1. Acquire all raw data from measuring devices using input hardware interfaces. This step generally involves obtaining information about the angle of the frame 12 from the longitudinal inclination measuring apparatus 50 and the angle between the frame 12 and the subframe 34 from the subframe angle measuring apparatus 56. The data is preferably all acquired substantially simultaneously, for example within one millisecond, because using precise geometry and precise measurements at each position of the surface profiler 10 along the path will increase the accuracy of the surface profile. Measurements from the measuring devices are preferably conditioned by signal conditioner 74 to remove noise and improve quality prior to performing calculations. Analog voltage signals entering the multi-channel analog to digital converter may be provided anti-aliasing filters. “Anti-aliasing” involves the application of passive resistor-capacitor low pass filters to incoming analog signals to limit the frequencies applied to the inputs of analog to digital converters to one-half of the digital sampling frequency, which is known as the Nyquist frequency, to avoid digitization errors. Digital values derived from the analog to digital converter may be digitally filtered using a band pass digital filter that passes only signal frequencies containing useful information.

2. Determine the distance travelled. In the embodiment shown, this is accomplished by accumulating the counts of electrical pulses from the longitudinal distance measuring apparatus 54, preferably being an optical encoder, and dividing by a scaling factor that converts the number of pulses to a distance Dnew travelled along the profile, in meters. However, any method suitable to accurately obtain and provide the distance travelled by the profiler may be employed.

3. Determine the incremental distance AD travelled. This simply uses the formula:

ΔD=D_{new}−D_{old}

where D_{old} is the distance travelled and stored during the iteration of the measurement subroutine. ΔD may be as small as approximately 1 mm and may vary depending on speed of the surface profiler 10 but the method is generally independent of speed. The current distance value D_{new} is stored for use at the next measurement interval as D_{old}.

4. Convert the data acquired into useful or engineering values. This step involves scaling digital values from the analog to digital converter to voltages and then to engineering quantities of angles in radians and distances in meters. The value of a obtained from the longitudinal inclination measuring apparatus 50, comprising an inclinometer, will be in radians. The value of β obtained using the digital counters or Synchronous Serial Interface (SSI) in 72 from the subframe angle measuring apparatus 56, comprising an optical encoder, will be in digital form which is easily converted to radians given the cycles, or counts, or 2^{bits} counts, per revolution of the subframe angle optical encoder and 2π radians per revolution.

5. Calculate the nth incremental change in elevation ΔEₙ using the formula:

ΔEₙ=ΔDₙ sin(αₙ+βₙ). ΔEₙ is then added to the accumulated elevation series as:

Eₙ=E₀+ΔE₁+ΔE₂ . . . +ΔEₙ

6. Return to step 1 at the next increment.

The mathematical elevation series created captures within the resulting profile all wavelengths from L to the longest wavelengths of interest. At L, the gain of the device becomes zero. Above L, all frequencies are captured without phase shift or distortion with the result that large and small profile features such as bumps, dips and cracks are captured with correct amplitude and longitudinal distance.

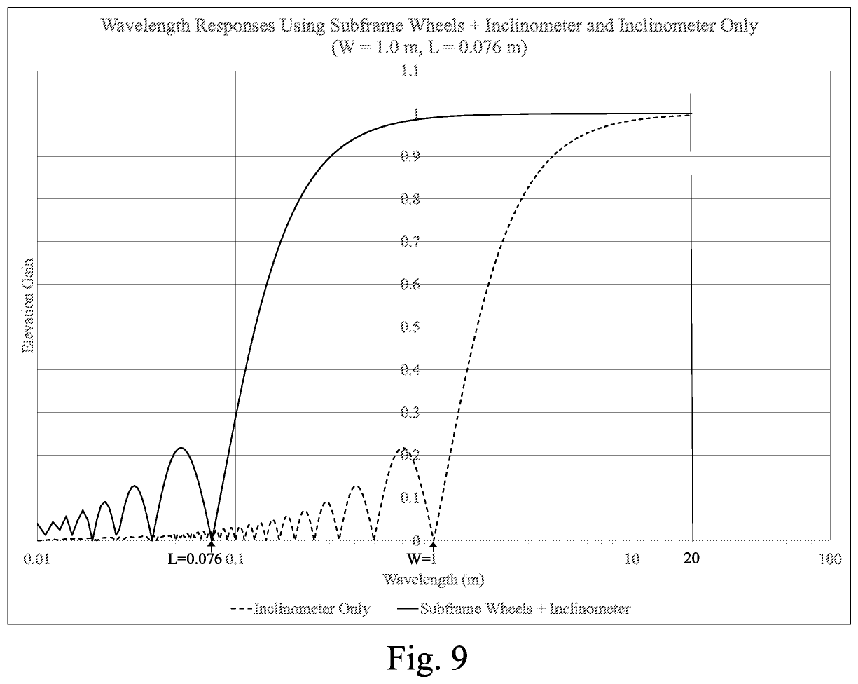

FIG. 9 shows how the addition of subframe support wheels 38, 40 in this example being subframe support wheels 38, 40 spaced about 76 mm apart mounted to a surface profiler 10 having a wheelbase W of about 1000 mm, can extend the short wavelength response over the 76 mm-1000 mm range, as compared to an otherwise identical profiler using only an inclinometer, that is where β is always zero because of the absence of subframe support wheels 38, 40 to derive β. Overall, the performance of this configuration of subframe support wheels profiler is smooth and accurate from 76mm to effectively infinite millimeters, and in particular provides useful information in the region between the wheelbase separation distance W, down to intermediate wheel separation distance L.

### Correction and Compensation

The measurement of the surface profile is accomplished using a combination of inclination measurements and subframe angle measurements. The longitudinal inclination measuring apparatus 50 is able to measure profile independently of the subframe angle measuring apparatus 56 measurements using the formula:

ΔE=ΔD sin(α)

However, as shown in FIG. 9, when the wavelength A of any surface feature is equal to or is less than W (for example 1 m), the longitudinal inclination measuring apparatus 50 alone loses effectiveness, and the surface profiler 10 is incapable of accurately detecting these features. Where the feature wavelength A is equal to W, the surface profiler 10 remains horizontal relative to the plane of the earth at all positions on the profile so the angle α measured by the longitudinal inclination measuring apparatus 50 remains constantly at zero, meaning the response gain of the surface profiler 10 is zero at this wavelength. The use of the subframe support wheels 38, 40 and subframe angle measuring apparatus 56 therefore extends the wavelength range of the invention into the range of A between W and L, enabling high resolution measurement of surface features. For features having wavelengths A between W and L, the combination of longitudinal inclination measuring apparatus 50 and subframe angle measuring apparatus 56 work together to measure the profile using the formula:

ΔE=ΔDD sin(α+β)

In practice, despite efforts to accurately calibrate and zero the subframe angle optical encoder it is possible the subframe angle measuring apparatus 56 will be nonzero when the surface profiler 10 is placed on a perfectly straight or planar surface with or without tilting relative to the horizontal plane of the earth. Also, for very long wavelength sine wave profiles, the subframe support wheels 38, 40 with subframe angle measuring apparatus 56 “see” a straight line and produce no β signal. At 20 times W (20 m where W is 1.0 m), the contribution of the subframe support wheels 38, 40 with subframe angle measuring apparatus 56 to the total profile, or their gain, is nearly zero compared to the longitudinal inclination measuring apparatus 50, which is nearly 1.0. At 20 times W, the angle of the subframe signal will be very small relative to the resolution or cycles per revolution of the subframe angle measuring apparatus 56. This may result in poor performance of the surface profiler 10 if the long wavelength component of the β signal is not removed. Therefore, it may be necessary to wavelength high pass filter β using a high pass digital filter with a cutoff wavelength of approximately 20 times W. This involves filtering in the distance domain (cycles/meter) rather than the frequency domain (cycles/second) and requires the ΔD values to be fairly constant. In this way, even if β is not exactly equal to zero for a perfectly straight profile, there will be no non-zero value of β that errantly causes the profile elevation to wander and result in large elevation errors at the end of the profile, since the high pass digital filter will make β equal to zero for very long wavelengths. Filtering out very long wavelengths from the β signal as described requires the support wheels 14, 16 and subframe support wheels 38, 40 be collinear to ensure the component of the profile contributed by the inclinometer is aligned with the component of the profile contributed by the subframe angle measuring apparatus 56 particularly through the crossover region at 20 times W.

A typical inclinometer is basically an accelerometer that responds to the direction of the acceleration of gravity using a pendulum that is balanced to the zero position by a miniature torque motor. The electrical current to the torque motor required to maintain the pendulum in the zero position is proportional to the sine of the angle of inclination and is the source of the voltage signal produced by the inclinometer. Such devices are also sensitive to acceleration of the inclinometer along the sensitive axis, such as may be caused by the operator pushing on the handle of the surface profiler 10 to start it moving, and pulling on the handle to stop it. If the longitudinal inclination measuring apparatus 50 comprises an inclinometer, the inclinometer will also be sensitive to the normal acceleration and deceleration inherent in starting and stopping the surface profiler 10. In order to correct this sensitivity, it may be necessary to calculate a compensating signal using high resolution distance information from the longitudinal distance measuring apparatus 54, if the information is available. By differentiating the distance signal D twice, an acceleration signal A can be derived. This differentiation may be performed on the digital representation of distance obtained from the longitudinal distance measuring apparatus 54. By appropriately scaling this acceleration with constant k, an equal and opposite compensation signal can be added to the inclinometer signal i to eliminate this issue. Specifically, this is accomplished as follows:

dD/dt=velocity V

dV/dt=acceleration A

i_{corrected}=i_{uncorrected}−k A

In some cases, the longitudinal inclination measuring apparatus 50, conveniently an inclinometer, produces an errant signal when tilted in the transverse direction, a characteristic known as cross-axis error. Cross-axis error is caused by misalignment between the axis of the sensing accelerometer element in the longitudinal inclinometer with its enclosure, or misalignment between the enclosure of the inclinometer with the longitudinal axis of the profiler. Either misalignment exposes the sensing accelerometer element to tilting in the transverse direction. If a transversely-aligned (or cross-axis) transverse inclination measuring apparatus, conveniently an inclinometer, 52 is provided to measure the angle χ between the horizontal plane of the earth and the frame in the transverse direction, it may provide information to correct the longitudinal inclinometer angle α for cross-axis error. The correction is applied to the voltage output from the inclinometer prior to conversion to angle. The longitudinal inclinometer voltage V_{α} is compensated for cross-axis error as follows.

$${V}_{α c} = {V}_{α} + {S}_{α to χ} x \frac{{V}_{c} - {V}_{c offset}}{{S}_{c}}$$

where:
V_{αc} is the longitudinal inclinometer voltage, after compensation, in volts;
V_{α} is the longitudinal inclinometer voltage, before compensation, in volts;
S_{α} to χ is the longitudinal inclinometer's (or α's) sensitivity to tilting in x direction in volts/G, determined empirically;
V_{χ} is the transverse, or cross-axis, inclinometer voltage in volts;
V_{χ} offset is the transverse inclinometer voltage output measured when the inclinometer is set horizontal relative to the plane of the earth in volts, determined empirically; and
Sₓ is the full range sensitivity of the transverse inclinometer in volts/G.

Then the cross-axis compensated angle α is given by:

$$α = {sin}^{- 1} \frac{{V}_{α c}}{{S}_{α}}$$

where S_{α} is the full range sensitivity of the longitudinal inclinometer in volts/G.

The present invention, given its high accuracy and repeatability, while finding uses in several industries and for many purposes, will be of particular value in both the contract management of new surface construction and as a reference standard for certification of other instruments.

The foregoing embodiment of the invention has been described as a rolling/walking profiler, having an operator to physically move the apparatus along the surface being profiled. However, it is also contemplated to provide a motorized drive mechanism for the apparatus, which can move the apparatus along the surface at a controllable speed. In a further alternative, the apparatus may comprise appropriate attachment means by which it can be attached to a motorized vehicle, which will then move the apparatus along the surface to be profiled, such as by towing or pushing. In yet a further alternative, the apparatus may include one or more motors, or the apparatus is integrated into a motor vehicle, which will then move the apparatus along the surface to be profiled.

In the foregoing specification, the invention has been described with reference to specific embodiments thereof. However, the scope of the claims should not be limited by the preferred embodiments set forth in the examples, but should be given the broadest interpretation consistent with the description as a whole. The specification and drawings are, accordingly, to be regarded in an illustrative rather than a restrictive sense.

What is claimed is:

1. A surface profiling apparatus comprising:
a frame;
a plurality of support wheels supporting said frame, at least two of said support wheels being separated by a support wheel spacing W and being aligned to contact a surface being profiled in a longitudinally collinear manner;
a longitudinal distance measuring apparatus supported by said frame for measuring distance traveled by said surface profiling apparatus;
a longitudinal inclination measuring apparatus supported by said frame for measuring an inclination angle α of said frame relative to a horizontal plane of the earth;
a subframe pivotally coupled to said frame;
a plurality of subframe support wheels supporting said subframe, at least two of said subframe support wheels being separated by subframe wheel spacing L and being aligned to contact said surface being profiled in a longitudinally collinear manner with said at least two support wheels;
a subframe angle measuring apparatus for measuring an angle β between said frame and said subframe.

2. The surface profiling apparatus of claim 1 wherein said longitudinal inclination measuring apparatus is an inclinometer.

3. The surface profiling apparatus of claim 1 wherein said subframe support wheels are equidistant from a mid-point of said frame.

4. The surface profiling apparatus of claim 1 wherein said subframe angle measuring apparatus is an optical encoder.

5. The surface profiling apparatus of claim 1 wherein said subframe further comprises:
a subframe member;
a subframe support member pivotally coupled to said subframe member; and
a rotational linkage pivotally coupled to said frame and to said subframe support member.

6. The surface profiling apparatus of claim 5 wherein said subframe support wheels are attached to said subframe member at said subframe wheel spacing L, and wherein said subframe wheel spacing L is shorter than said support wheel spacing W.

7. The surface profiling apparatus of claim 5 wherein said rotational linkage is a parallelogram rotational linkage.

8. The surface profiling apparatus of claim 5 wherein said angle measuring apparatus is an optical encoder attached to said subframe member.

9. The surface profiling apparatus of claim 5 wherein said angle measuring apparatus is a magnetic encoder attached to said subframe member.

10. The surface profiling apparatus of claim 5 wherein said subframe support member is pivotally coupled to said subframe member at said subframe member's midpoint.

11. The surface profiling apparatus of claim 5 wherein said subframe support wheels are equidistant from a mid-point of said frame.

12. The surface profiling apparatus of claim 1 wherein said longitudinal distance measuring apparatus is rotationally linked to an axle of one of said support wheels.

13. The surface profiling apparatus of claim 1 wherein said longitudinal distance measuring apparatus is an optical encoder.

14. The surface profiling apparatus of claim 8 wherein said longitudinal distance measuring apparatus is an optical encoder.

15. The surface profiling apparatus of claim 1 further comprising a motorized drive adapted to move the profiling apparatus along the surface to be profiled.

16. The surface profiling apparatus of claim 1 further comprising attachment means by which said surface profiling apparatus may be attached to a motorized vehicle to move said surface profiling apparatus along said surface being profiled.

17. The surface profiling apparatus of claim 1 further comprising an operator interface to control said profiling apparatus.

18. The surface profiling apparatus of claim 17 wherein said operator interface is associated with a cabinet associated with said frame.

19. The surface profiling apparatus of claim 18 wherein said cabinet houses operational equipment, said operational equipment being selected from the group consisting of: one or more internal sensors, a power supply, power level monitor, signal conditioning equipment, real time clock, distance pulse counters, digital input/output and multi-channel 116 bit analog to digital converter, computer and non-volatile memory.

20. The surface profiling apparatus of claim 1 further comprising a transverse inclination measuring apparatus, supported by said frame and oriented substantially perpendicular to said longitudinal inclination measuring apparatus.

21. The surface profiling apparatus of claim 20 wherein said transverse inclination measuring apparatus is an inclinometer.

22. A method of profiling a surface using a surface profiler mounted on a plurality of support wheels, at least two of said support wheels being aligned to contact the surface in a longitudinally collinear manner, and a subframe supported by a plurality of subframe support wheels, at least two of said subframe support wheels being aligned to contact the surface in a longitudinally collinear manner and being mounted collinearly with said support wheels and separated by a subframe wheel spacing L, the method comprising:
acquiring data relating to:
a longitudinal distance ΔD travelled by said surface profiler from a longitudinal distance measuring apparatus mounted on said profiler;
an angle α from a longitudinal inclination measuring apparatus comprising a first inclinometer mounted on said surface profiler; and
an angle β between said frame and said subframe from an optical encoder;
calculating an incremental change in surface elevation ΔE, using the formula:
ΔE=ΔD sin(α+β); and
adding said incremental change to an accumulated elevation series
which represents a profile of said surface.

23. The method of claim 22, wherein said method is applied at periodic intervals.

24. The method of claim 23 wherein said periodic intervals are at time increments, At.

25. The method of claim 24 wherein Δt is 1 millisecond.

26. The method of claim 23 wherein said periodic intervals are at longitudinal distance increments, ΔD.

27. The method of claim 26 wherein ΔD is 1 millimeter.

28. The method of claim 22 wherein said step of acquiring data further comprises acquiring data relating to a transverse angle χ from a transverse inclination measuring apparatus comprising a second inclinometer supported by said surface profiler to correct said angle α for cross-axis error.

29. The method of claim 28 wherein said method is applied at periodic intervals.

30. The method of claim 29 wherein said periodic intervals are at time increments, Δt.

31. The method of claim 30 wherein Δt is 1 millisecond.

32. The method of claim 28 wherein said periodic intervals are at longitudinal distance increments, ΔD.

33. The method of claim 32 wherein ΔD is 1 millimeter.

34. A method of profiling a surface using a surface profiler mounted on a plurality of support wheels, at least two of said support wheels being aligned to contact the surface in a longitudinally collinear manner, said surface profiler further comprising a subframe connected to said surface profiler and supported by a plurality of subframe support wheels, at least two of said subframe support wheels being aligned to contact the surface in a longitudinally collinear manner, the method comprising:
moving said surface profiler a longitudinal distance increment ΔD;
obtaining an angle α from a longitudinal inclination measuring apparatus comprising a first inclinometer mounted on said surface profiler;
obtaining an angle β from an angle measuring apparatus comprising an optical encoder connected between said subframe and a frame of said surface profiler;
calculating an incremental change in surface elevation ΔE, using the formula:
ΔE=ΔD sin(α+β);
and adding said incremental change to an accumulated elevation series which represents a profile of said surface.

35. The method of claim 34 wherein said method is applied at periodic intervals.

36. The method of claim 35 wherein said periodic intervals are at time increments, Δt.

37. The method of claim 36 wherein Δt is 1 millisecond.

38. The method of claim 35 wherein said periodic intervals are at longitudinal distance increments, ΔD.

39. The method of claim 38 wherein ΔD is 1 millimeter.

40. The method of claim 34 comprising the further step of correcting said angle α for cross-axis error using a transverse angle χ, said transverse angle x being obtained from a transverse inclination measuring apparatus comprising a second inclinometer supported by said surface profiler.
